(19) United States
(12) Patent Application Publication
(10) Pub. No.: US 2008/0007859 A1
(43) Pub. Date: Jan. 10, 2008

(54) Recorded Data Eraser for Magnetic Recording Medium, Method for Erasing Recorded Data in Magnetic Recording Medium, and Program for Controlling Said Eraser

(76) Inventor: Kazushige Komori, Nara (JP)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/794,259

(22) PCT Filed: Dec. 27, 2004
(86) PCT No.: PCT/JP04/19507

§ 371 Date: Jun. 26, 2007

(51) Int. Cl. G11B 5/02

(52) U.S. Cl. 360/66

(57) ABSTRACT

There is provided a device and a method adapted to confirm whether data is completely erased when erasing data in a magnetic recording medium. A recorded data eraser for erasing data recorded in a magnetic recording medium by means of a magnetic field includes an input voltage monitor for monitoring an input voltage of electricity supplied to an excitation controlling part for exciting a coil, a charging voltage monitor for monitoring a charging voltage of a capacitor, and an operation checking part having a warning means for warning an anomaly based on the outputs from the two monitors.

### BACKGROUND OF THE INVENTION

1. Field of the Invention

The present invention relates to a recorded data eraser for a magnetic recording medium used for erasing data recorded in a magnetic recording medium such as a hard disk drive, a magnetic tape, or a flexible disk, to a method for erasing recorded data in a magnetic recording medium, and to a program for controlling said eraser.

2. Description of the Related Art

When a magnetic recording medium such as a hard disk drive, a flexible disk, or a magnetic tape is discarded or reused, for example, data recorded in the medium are commonly erased in view of preventing leakage of data.

An eraser constituted by a toroidal coil wound around an outer periphery of a ring-shaped core, arranged in a main body of the eraser, and connected to an AC power source is known as one for erasing data recorded in these media (for example, refer to patent document 1).

The eraser arranges a medium such as a flexible disk or a tape at an outer face of the main body of the eraser and applies an alternating current to the coil from the AC power source so as to generate an alternating magnetic field, whereby data recorded in the medium is erased.

The applicant of this application has already applied a device for erasing data recorded in a magnetic recording medium by a magnetic field, which is generated by a coil using electricity having been charged in a capacitor.

Patent Document 1: Japanese Patent No. 2545451
Patent Document 2: Japanese Patent Application No. 2002-356962
Patent Document 3: Japanese Patent Application No. 2002-356965

### SUMMARY OF THE INVENTION

### PROBLEMS TO BE SOLVED BY THE INVENTION

The above-mentioned data eraser is designed to erase recorded data by using a magnetic field, and thus, a state of erasure operation cannot be checked with eyes and a medium after the erasure operation has no change in appearance. Therefore, it is not easy to confirm whether data in a magnetic recording medium is completely erased or not after the erasure operation. In other words, though the erasure operation would be performed, an eraser can have some sort of anomaly, having intensity of magnetic field that fails to meet a predetermined value or generating no magnetic field at all, resulting in possible incomplete erasure of data. In order to confirm whether data recorded in a magnetic recording medium after erasure operation is completely erased, it is necessary to connect the medium to a device such as a computer each time.

It is therefore an object of the present invention made in view of such technical background to provide an improved recorded data eraser for a magnetic recording medium adapted to confirm that data recorded in a magnetic recording medium is erased, a method for erasing recorded data, and a program for controlling the recorded data eraser.

### MEANS TO SOLVE THE PROBLEMS

An aspect of the present invention to solve the problems described above is a recorded data eraser for a magnetic recording medium including a coil for generating a magnetic field and an excitation controlling part for exciting the coil and having a capacitor, the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field, the eraser further including a charging voltage monitor for monitoring the charging voltage of the capacitor and transmitting an output corresponding to the voltage and an operation checking part for receiving the output from the charging voltage monitor and executing anomaly management based on the output.

It is preferable that the operation checking part is adapted to execute the anomaly management based on charging time and the charging voltage of the capacitor.

It is preferable that the recorded data eraser further includes an input voltage monitor for monitoring voltage of electricity inputted in the eraser and that the operation checking part is adapted to execute the anomaly management based on outputs from the input voltage monitor and the charging voltage monitor.

The anomaly management is recommended to indicate an anomaly to users or to stop data erasure operation. The anomaly management may perform both of indicating of the anomaly and stopping of the operation. The same applies to the invention of a method described below.

Preferably, the coil is adapted to generate an attenuating alternating magnetic field whose peak value reduces as time passes. The same applies to the invention of the method described below.

Another aspect of the invention to solve a similar problem is a method for erasing recorded data in a magnetic recording medium by a magnetic field, using a recorded data eraser including a coil for generating a magnetic field and an excitation controlling part for exciting the coil and having a capacitor, the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field, including the steps of determining before data erasure operation whether a condition that the capacitor has a capacity equal to or more than a predetermined value is satisfied and executing anomaly management in the case that the condition is not satisfied.

It is preferable that the method further includes the steps of determining whether a condition that an input voltage of the electricity supplied to the excitation controlling part is within a predetermined range is satisfied and executing the anomaly management in the case that the condition is not satisfied in addition to the above-mentioned case.

It is also recommended that the method further includes the steps of determining whether a condition that the capacitor after a predetermined period of time from startup of the data erasure operation has the charging voltage equal to or below a predetermined value close to 0V and executing the anomaly management in the case that the condition is not satisfied.

It is also preferable that the method further includes the steps of determining whether a condition that the input voltage after the data erasure operation is within a predetermined range, determining whether a condition that the capacitor after the data erasure operation has a capacity equal to or more than a predetermined value, and executing the anomaly management in the case that at least one of the conditions is not satisfied.

Still another aspect of the invention to solve a similar problem is a method for erasing recorded data in a magnetic recording medium by a magnetic field, using a recorded data eraser including a coil for generating a magnetic field and an excitation controlling part for exciting the coil and having a capacitor, the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field, including the steps of determining whether a condition that the capacitor after a predetermined period of time from startup of data erasure operation has the charging voltage equal to or below a predetermined value close to 0V and executing anomaly management in the case that the condition is not satisfied.

In addition to the above-mentioned configuration, it is recommended that the method further includes the steps of determining whether a condition that an input voltage of the electricity supplied to the excitation controlling part is within a predetermined range, determining whether a condition that the capacitor has a capacity equal to or more than a predetermined value, and executing the anomaly management in the case that at least one of the conditions is not satisfied.

Herein, whether the condition that the capacitor has a capacity equal to or more than the predetermined value is satisfied can be determined by time duration of charging and the charging voltage when the capacitor is charged.

Yet another aspect of the invention is a program for controlling a recorded data eraser for a magnetic recording medium by a magnetic field, including the steps of determining whether a condition that an input voltage of electricity supplied to an excitation controlling part so as to excite a coil for generating the magnetic field is within a predetermined range, determining before data erasure operation whether a condition that a capacitor for generating the magnetic field has a capacity equal to or more than a predetermined value is satisfied, and issuing a warning and/or stop the data erasure operation in the case that at least one of the conditions is not satisfied, the program, in the case that the data erasure operation is executed, further including the steps of determining whether a condition that the capacitor after a predetermined period of time from startup of the data erasure operation has a charging voltage equal to or below a predetermined value close to 0V, determining whether a condition that the input voltage of the electricity supplied to the excitation controlling part is within a predetermined range, determining whether a condition that the capacitor has a capacity equal to or more than a predetermined value is satisfied, and issuing a warning in the case that at least one of the conditions is not satisfied.

The above-mentioned program is stored in a recorded data eraser for a magnetic recording medium.

### ADVANTAGEOUS EFFECT OF THE INVENTION

According to the above-mentioned invention, the data eraser for a magnetic recording medium senses erasing capacity degradation caused by an anomaly of the eraser or disturbance such as an input voltage reduction in a time, for example, before data erasure operation. Consequently, useless data erasure operation such that recorded data is not completely erased or a useless subsequent confirmation work is saved.

Further, even if having no problem in a preliminary check, the eraser monitors a discharging condition of the capacitor incorporated in the eraser and makes the same check as that before data erasure operation again after the operation. Therefore, when having no problem in these checks, it is inferred that the data erasure operation performed between the preliminary and posterior checks has worked well. That reduces or eliminates work to read a magnetic recording medium using a device such as a computer in order to confirm data erasing condition, thereby reducing a burden of the overall data erasure operation.

### BRIEF DESCRIPTION OF THE DRAWINGS

FIG. 1 is a perspective view of a recorded data eraser for a magnetic recording medium relating to an embodiment of the present invention;

FIG. 2 is a partly broken side view of the data eraser;

FIG. 3 is a perspective view of a coil and a box-shaped casing of the data eraser; and

FIG. 4 is an electrical circuit showing a DC power circuit in the data eraser.

### DESCRIPTION OF THE PREFERRED EMBODIMENTS

Now, a preferred embodiment of the present invention will be described below, making reference to the accompanying drawings.

In the following description, a hard disk drive is exemplified as a magnetic recording medium whose data is to be erased, but the present invention can be applied to other magnetic recording media such as a magnetic tape or a flexible disk, as well.

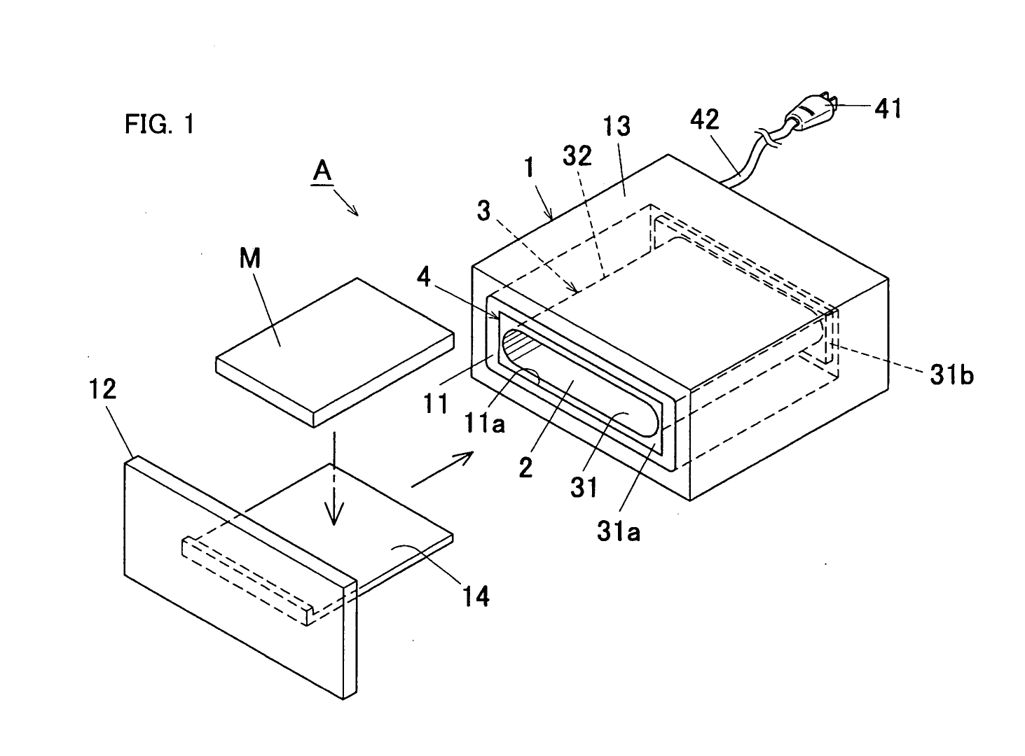

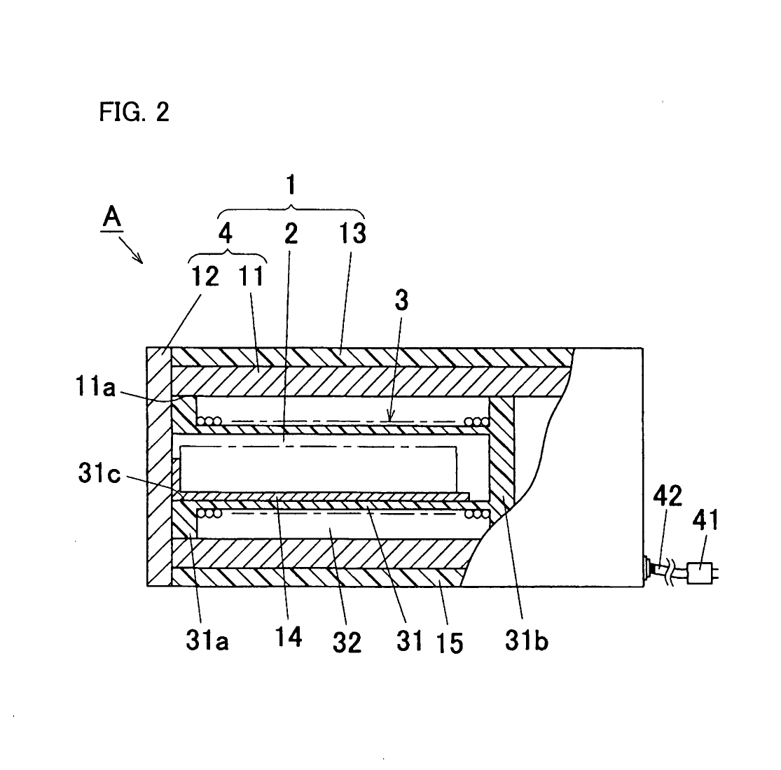

Referring to FIGS. 1 and 2, a recorded data eraser A includes a device body 1, an insertion cavity 2 arranged in the device body 1, into which a hard disk drive M is inserted, a magnetic field generator 3 arranged in the device body 1, and a magnetic body 4 arranged in a magnetic field to be generated by the magnetic field generator 3.

The device body 1 consists mainly of a box-shaped casing 11 having an opening 11a at its front, a lid 12 being openable and closable of the openings 11a of the casing 11, and a box-shaped outer covering 13 made of resin having an opening at its front and arranged at outer periphery of the casing 11. The lid 12 closes the opening 11a of the casing 11, thereby also openably and closably closing the opening of the outer covering 13.

A plate-like holder 14 protruding backward in a horizontal posture is secured at its proximal end to a rear surface of the lid 12. The hard disk drive M is to be mounted on an upper surface of the holder 14. The holder 14 is formed into such a size as to be inserted into the cavity 2 with holding the drive M when the opening 11a of the casing 11 is closed by the lid 12. The holder 14 is only necessary to support the drive M, and not limited to a plate-like one. Further, in the case that the drive M is inserted into the cavity 2 in the device body 1 directly by a user, the lid 12 may be openably and closably attached to an open end of the casing 11 or of the outer covering 13 by a means such as a hinge.

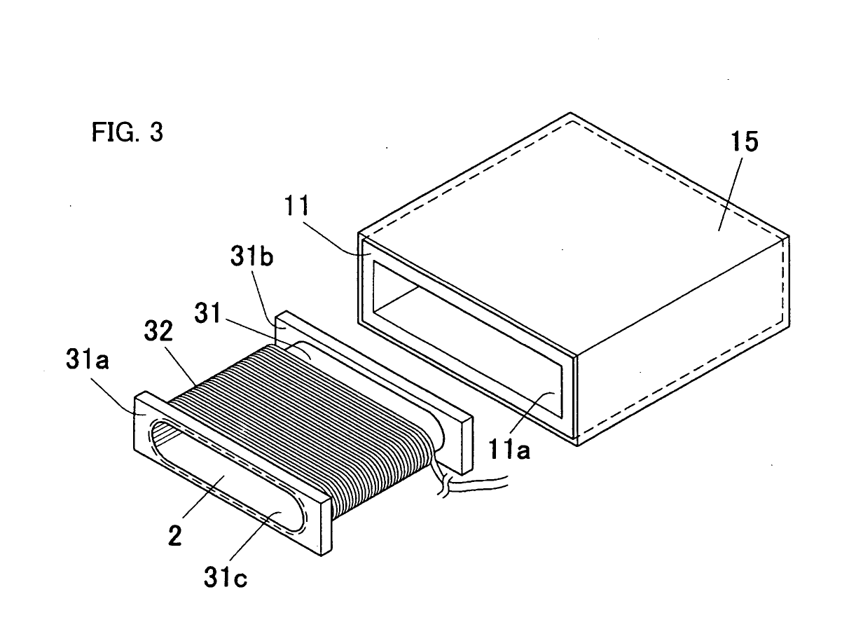

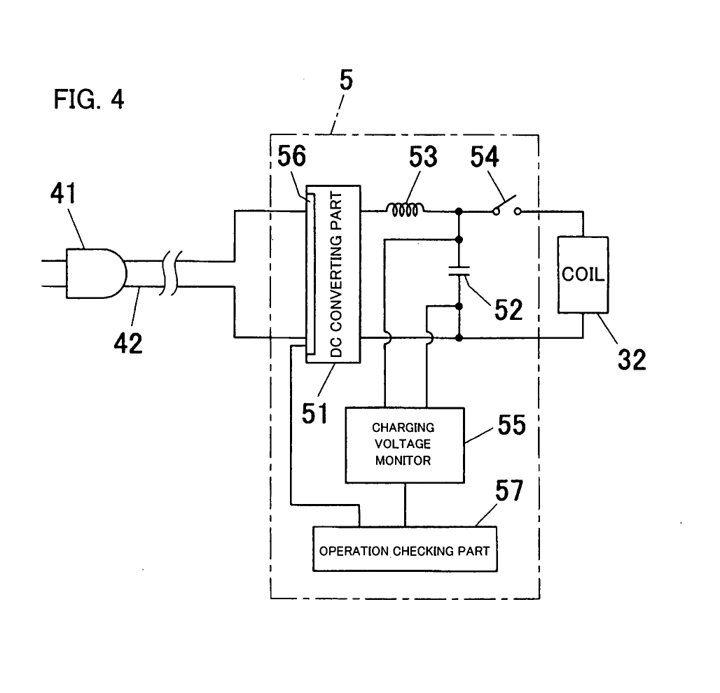

Referring to FIG. 3, the magnetic field generator 3 consists mainly of a coil 32, for example, wound around an outer periphery of a coil spool 31 more than once along a longitudinal direction and a DC power circuit (FIG. 4). The coil spool 31 is a flattened cylinder, inside of which is the cavity 2. The coil spool 31 has at its front and back ends a front and a rear flanges 31a and 31b integrated with both the ends, respectively.

The coil spool 31 is contained in the casing 11 so that the front flange 31a is fitted within the opening 11a of the casing 11, and is positioned via the flanges 31a and 31b, an opening 31c of the front flange 31a being a front opening of the cavity 2, that is, an insertion slot of the drive M.

The coil 32 generates a magnetic field in a direction penetrating the cavity 2 of the coil spool 31 by an excitation controlling part 5. The generated magnetic field erases recorded data in a hard disk (not shown) of the drive M.

The casing 11 and the lid 12 each are made of a ferromagnetic material such as a plate-like iron or its alloy material, forming the magnetic body 4. The magnetic body 4 has functions of increasing magnetic flux within the cavity 2 caused by a magnetic field generated by the coil 32 and equalizing a magnetic flux density in a transverse section of the cavity 2, so as to add the magnetic flux to the drive M. In other words, the magnetic body 4 is designed to promote and equalize data erasing effect by a magnetic field of the coil 32. That would be because the casing 11 and the lid 12 made of an iron material as described above facilitate magnetic field lines generated by the coil 32 passing therethrough, thereby achieving increase of magnetic flux and equalization of a magnetic flux density within the cavity 2. In particular, a magnetic intensity is strong at the open end (adjacent to the insertion slot of the drive M) of the casing 11. The magnetic body 4 is not limited to an iron material as described above and may be another ferromagnetic material such as nickel.

Further, the casing 11 and the lid 12 may be made of a paramagnetic material such as aluminum or titanium. Such a material also increases magnetic flux and equalizes a magnetic flux density within the casing 2. That would be because a magnetic field generates eddy current on a surface or inside of the casing 11 and the lid 12, the eddy current further generating a magnetic field.

As shown in FIG. 4, the device body 1 includes the excitation controlling part 5 so as to excite the coil 32. The excitation controlling part 5 includes a DC converting part 51 for converting a commercial AC power source voltage, which is inputted via a power cord 42 having a plug 41 for connecting with a commercial alternating-current source, into a direct current of a predetermined voltage, a capacitor 52 connected in parallel to the coil 32 and to be charged by power supply from the DC converting part 51, a reactor 53 interposed in an input line from the DC converting part 51 to the capacitor 52, and a switching device 54 interposed between the capacitor 52 and the coil 32.

Further, the excitation controlling part 5 includes a charging voltage monitor 55 adapted to measure a charging voltage (voltage between terminals) of the capacitor 52 and an input voltage monitor 56 adapted to measure a voltage of electricity supplied from the plug 41.

Further the excitation controlling part 5 includes an operation checking part 57 adapted to analyze data transmitted from the charging voltage monitor 55 and the input voltage monitor 56, so as to issue a warning by means such as a buzzer or a light in the case that the data does not satisfy a predetermined condition, so as to stop to go on a next stage.

Now, how to use the data eraser A for a hard disk drive, having the above-mentioned configuration, will be described below.

While the switching device 54 of the excitation controlling part 5 is open, the eraser A is connected with a commercial AC power source via the power cord 42.

At this stage, data of an input voltage is transmitted from the input voltage monitor 56 to the operation checking part 57. The operation checking part 57 determines whether the input voltage is within a predetermined range, then, in the case that the input voltage is out of the predetermined range, warning an anomaly to users by means of a warning beep and a light and controlling the DC converting part 51 so as not to charge the capacitor 52. The predetermined range of the input voltage is within a range of plus or minus 5% in the case that a rated input voltage is 100V. In the present embodiment, since the rated input voltage is 100V, the predetermined range is 95V or more and 105V or less. Consequently, in the case that the input voltage is less than 95V or more than 105V, the operation checking part 57 warns an anomaly and controls operation of the DC converting part 51.

In the case that the input voltage is within the predetermined range, charging of the capacitor 52 is started. Then, the charging voltage monitor 55 measures a charging voltage of the capacitor 52 after a predetermined period of time from startup of the charging. The operation checking part 57 receives the transmitted value of the charging voltage, so as to determine whether the value is equal to or below a predetermined value. In the case that the charging voltage of the capacitor 52 is more than the predetermined value, the operation checking part 57 warns an anomaly to users by means of a warning beep and a light and controls the DC converting part 51 so as to stop charging the capacitor 52. The predetermined value of the charging voltage is 380V in the case that a rated capacity of the capacitor 52 is 4700 μF. The predetermined period of time described above and selected in the present embodiment is 5 seconds.

In this way, a high charging voltage (voltage between terminals) of the capacitor 52 after a predetermined period of time from startup of the charging implies a decreased capacity of the capacitor 52. Thus, a capacity of the capacitor 52 is monitored by such a processing as described above.

Herein, preferably, allowable deterioration of a capacitor is within a range of plus or minus 10% of a rated capacity. Less than minus 10% of a capacity of the capacitor increases the possibility that data is insufficiently erased.

Relationship between charging time and charging voltage (voltage between terminals) after startup of the charging depends on a rated capacity of a capacitor in checking deterioration of the capacitor, and thus, can be determined based on data of relationships between the charging time and the charging voltage to an undeteriorated capacitor and between the charging time and the charging voltage to a deteriorated capacitor having minus 10% of a rated capacity. These relationships can be found out in advance.

If no anomaly is detected by the double checks described above, the capacitor 52 is charged so as to prepare data erasure operation.

Then, the hard disk drive M whose recorded data is necessary to be erased is mounted on the holder 14 with its thickness direction put in a heightwise direction. This operation may be done before the checks described above. Then, the holder 14 enters the cavity 2 and the opening 11a of the casing 11 is closed by the lid 12, so that the drive M is inserted into the cavity 2 as illustrated in FIG. 2.

Next, the erasure operation is carried out. Before startup of the erasure operation, charging of the capacitor 52 has been completed in the excitation controlling part 5, so that the supply of electricity has been already cut off. In this condition, closing of the switching device 54 discharges electricity in the capacitor 52 to the coil 32, thereby generating a magnetic field in an interior space of the coil 32, that is, the cavity 2 in which the drive M is placed. Magnetic lines caused by the magnetic field penetrate a metal casing of the drive M, so as to erase data including data such as cylinder information recorded in the hard disk inside.

The magnetic field generated in the coil 32 is preferably an attenuating alternating magnetic field whose peak value reduces as time passes. Specifically, the attenuating alternating magnetic field denotes a magnetic field in which a magnetic flux density reduces with alternately reversing a magnetic pole.

Generally, a rapid application of a magnetic field around a magnetic body magnetizes the magnetic body in a predetermined strength. Further, arrangement of a magnetized magnetic body in a magnetic field and gradual reducing of strength of the magnetic field to zero or gradual keeping of the magnetized magnetic body away from the magnetic field demagnetize the body. Such a demagnetization characteristic is also applied to a device such as a head eraser of a magnetic head for use in a tape recorder or a video recorder.

While carrying on the erasure operation, the charging voltage monitor 55 constantly monitors a voltage of the capacitor 52, and whereby the operation checking part 57 issues a warning that the erasure operation has not completed yet if the charging voltage of the capacitor 52 has not reached 0V after a predetermined time duration. Herein, the warning may be the same as in the preliminary checks or may use a different kind of warning beep or a different emission color or emission pattern for a warning. The predetermined time duration is 1 second in the present embodiment. Determination whether the charging voltage has reached 0V can be done based on an assumption of completion of discharging when the voltage is 3V or below in consideration of noise. Herein, when the voltage after the discharging is 3V or below, data is deemed to be sufficiently erased. When the voltage is 1V or below, data is deemed to be more sufficiently erased.

Next, whether the input voltage is within a predetermined range is determined again, and in the case that the input voltage is out of the predetermined range, an anomaly is warned to users by means of the warning beep and the light. The predetermined range in this check is the same as in the preliminary checks.

Further, charging of the capacitor 52 is started. The charging voltage monitor 55 measures the charging voltage of the capacitor 52 after a predetermined time duration from the startup of the charging, so as to determine whether the voltage is equal to a predetermined value or below. In the case that the charging voltage of the capacitor 52 is more than the predetermined value, an anomaly is warned to users by means of the warning beep and the light. The predetermined time duration and the predetermined value are the same as in the preliminary checks.

In the above-mentioned embodiment, the hard disk drive M, i.e., a recording medium, is put alone in the data eraser 1, but is not limited thereto. The recording medium may be put in the eraser 1 in a discretionary manner. As described above, a recording medium such as a hard disk drive may be individually put in a magnetic field one at a time. A box containing therein a plurality of recording media may be put in a magnetic field. Further, a magnetic field may be applied to a device containing therein a hard disk drive, more specifically, to a computer device from outside thereof without detaching a hard disk from the computer device and with the disk installed in the computer device.

As described above, the data eraser of the present embodiment monitors the input voltage and the deteriorative state of the capacitor 52 before the erasure operation, so as to avoid useless erasure operation. Further, checking of a discharging state of the capacitor 52 during the erasure operation monitors an anomaly generated during the erasure operation, thereby inferring that data is insufficiently erased without using a computer to read contents of a hard disk drive, i.e., a magnetic recording medium. Further, when a predetermined condition is satisfied by determination of the input voltage and the deteriorative state of the capacitor 52 after the erasure operation, complete erasure of data recorded in a hard disk drive is inferred.

### INDUSTRIAL APPLICABILITY

The recorded data eraser for a magnetic recording medium relating to the present invention may be equipped in firms recycling magnetic recording media, offices using and discarding magnetic recording media, or commercial facilities working as contacts for recycling to collect magnetic recording media and is applicable to erasure of data recorded in such magnetic recording media.

1. A recorded data eraser for a magnetic recording medium comprising:
a coil for generating a magnetic field; and
an excitation controlling part for exciting the coil and having a capacitor;
the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field,
the eraser further comprising:
a charging voltage monitor for monitoring the charging voltage of the capacitor and transmitting an output corresponding to the voltage; and
an operation checking part for receiving the output from the charging voltage monitor and executing anomaly management based on the output.

2. The recorded data eraser as defined in claim 1, wherein the operation checking part is adapted to execute the anomaly management based on charging time and the charging voltage of the capacitor.

3. The recorded data eraser as defined in claim 1, further comprising an input voltage monitor for monitoring voltage of electricity inputted in the eraser,
wherein the operation checking part is adapted to execute the anomaly management based on outputs from the input voltage monitor and the charging voltage monitor.

4. The recorded data eraser as defined in claim 1, the anomaly management being adapted to indicate an anomaly to users.

5. The recorded data eraser as defined in claim 1, the anomaly management being to stop data erasure operation.

6. The recorded data eraser as defined in claim 1, wherein the coil is adapted to generate an attenuating alternating magnetic field whose peak value reduces as time passes.

7. A method for erasing recorded data in a magnetic recording medium by a magnetic field, using a recorded data eraser comprising a coil for generating a magnetic field and an excitation controlling part for exciting the coil and having a capacitor, the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field, comprising the steps of:
determining before data erasure operation whether a condition that the capacitor has a capacity equal to or more than a predetermined value is satisfied; and
executing anomaly management in the case that the condition is not satisfied.

8. The method as defined in claim 7, further comprising the steps of: determining whether a condition that an input voltage of the electricity supplied to the excitation controlling part is within a predetermined range is satisfied; and executing the anomaly management in the case that the condition is not satisfied.

9. The method as defined in claim 7, further comprising the steps of: determining whether a condition that the capacitor after a predetermined period of time from startup of the data erasure operation has the charging voltage equal to or below a predetermined value close to 0V; and executing the anomaly management in the case that the condition is not satisfied.

10. The method as defined in claim 7, further comprising the steps of: determining whether a condition that the input voltage after the data erasure operation is within a predetermined range; determining whether a condition that the capacitor after the data erasure operation has a capacity equal to or more than a predetermined value; and executing the anomaly management in the case that at least one of the conditions is not satisfied.

11. A method for erasing recorded data in a magnetic recording medium by a magnetic field, using a recorded data eraser comprising a coil for generating a magnetic field and an excitation controlling part for exciting the coil and having a capacitor, the eraser being adapted to charge the capacitor to a charging voltage, and then to discharge the capacitor so that electricity from the capacitor is supplied to the coil so as to generate a magnetic field, so that the data recorded in the magnetic recording medium is erased by the magnetic field, comprising the steps of:
determining whether a condition that the capacitor after a predetermined period of time from startup of data erasure operation has the charging voltage equal to or below a predetermined value close to 0V; and
executing anomaly management in the case that the condition is not satisfied.

12. The method as defined in claim 11, further comprising the steps of: determining whether a condition that an input voltage of the electricity supplied to the excitation controlling part is within a predetermined range; determining whether a condition that the capacitor has a capacity equal to or more than a predetermined value; and executing the anomaly management in the case that at least one of the conditions is not satisfied.

13. The method as defined in claim 12, wherein whether the condition that the capacitor has a capacity equal to or more than the predetermined value is satisfied is determined by time duration of charging and the charging voltage when the capacitor is charged.

14. The method as defined in claim 11, wherein the coil is adapted to generate an attenuating alternating magnetic field whose peak value reduces as time passes.

15. The method as defined in claim 11, the anomaly management being adapted to issue a warning.

16. The method as defined in claim 11, the anomaly management being adapted to stop the data erasure operation.

17. A program for controlling a recorded data eraser for a magnetic recording medium by a magnetic field, comprising the steps of:
determining whether a condition that an input voltage of electricity supplied to an excitation controlling part so as to excite a coil for generating the magnetic field is within a predetermined range;
determining before data erasure operation whether a condition that a capacitor for generating the magnetic field has a capacity equal to or more than a predetermined value is satisfied; and
issuing a warning and/or stop the data erasure operation in the case that at least one of the conditions is not satisfied,
the program, in the case that the data erasure operation is executed, further comprising the steps of:
determining whether a condition that the capacitor after a predetermined period of time from startup of the data erasure operation has a charging voltage equal to or below a predetermined value close to 0V;
determining whether a condition that the input voltage of the electricity supplied to the excitation controlling part is within a predetermined range;
determining whether a condition that the capacitor has a capacity equal to or more than a predetermined value is satisfied; and
issuing a warning in the case that at least one of the conditions is not satisfied.

18. A recorded data eraser for a magnetic recording medium, the eraser storing the program as defined in claim 17.

19. The method as defined in claim 7, wherein whether the condition that the capacitor has a capacity equal to or more than the predetermined value is satisfied is determined by time duration of charging and the charging voltage when the capacitor is charged.

20. The method as defined in claim 7, wherein the coil is adapted to generate an attenuating alternating magnetic field whose peak value reduces as time passes.

21. The method as defined in claim 7, the anomaly management being adapted to issue a warning.

22. The method as defined in claim 7, the anomaly management being adapted to stop the data erasure operation.
